(19) United States
(12) Patent Application Publication
(10) Pub. No.: US 2021/0350208 A1
(43) Pub. Date: Nov. 11, 2021

(54) METHOD AND DEVICE FOR PREDICTING PRODUCTION PERFORMANCE OF OIL RESERVOIR

(71) Applicant: China University of Petroleum (East China), Qingdao (CN)

(72) Inventors: Sen WANG, Qingdao (CN); Chaoxu QIN, Qingdao (CN); Qihong FENG, Qingdao (CN); Xiao WANG, Qingdao (CN); Yipu LIANG, Qingdao (US); Ling LIANG, Qingdao (CN)

(21) Appl. No.: 17/193,849

(22) Filed: Mar. 5, 2021

(30) Foreign Application Priority Data
May 11, 2020 (CN) 202010391407.7

(51) Int. Cl. G06N 3/04; G06F 30/20; G06N 3/08; E21B 49/08

(52) U.S. Cl. CPC G06N 3/0427; G06N 3/0472; G06F 2111/10; G06N 3/08; E21B 49/087; G06F 30/20

(57) ABSTRACT

The present disclosure provides a method and device for predicting a production performance of an oil reservoir. The method includes: determining a single-well numerical simulation data set according to geological parameters, rock and fluid parameters and construction data; performing reservoir numerical simulation based on the single-well numerical simulation data set, and determining a standard data set for oil reservoir production performance prediction; establishing a deep belief network (DBN) model for oil reservoir production performance prediction according to the standard data set; and predicting the production performance of a target well by using the DBN model to obtain a production performance prediction result of the target well. The present disclosure can be used to fast and accurately predict the production performance of an oil well in an unconventional oil reservoir. For a given block, the DBN model can be used indefinitely without the target well being put into production.

### CROSS REFERENCE TO RELATED APPLICATION

This application claims priority to Chinese patent application No. 02010391407.7, filed on May 11, 2020, the disclosure of which is incorporated herein by reference in their entireties.

### TECHNICAL FIELD

The present disclosure relates to the technical field of petroleum exploitation, in particular to a method and device for predicting a production performance of an oil reservoir.

### BACKGROUND

At present, the exploitation of conventional oil and gas resources is showing a downward trend, while the total demand for oil and gas resources in the world is still on the rise. The contradiction between the supply and demand of oil and gas resources is becoming increasingly prominent. China's unconventional oil reservoirs, especially tight oil/shale oil reservoirs, have abundant reserves and are an important alternative for conventional oil. Unconventional oil generally refers to super-heavy crude oil, tar sands oil, tight oil, shale oil, etc. At present, tight oil/shale oil has become a hot spot in China's unconventional oil development. During the development process, the accurate prediction of the tight oil/shale oil production performance is of great significance to fracturing construction design and economic and efficient development of oil reservoirs.

At present, the production performance prediction methods for unconventional oil reservoirs such as tight oil/shale oil reservoirs have the following problems:

Firstly, most of the existing production performance prediction methods for unconventional oil reservoirs require that the oil well has already started production, that is, they use the existing production performance data of the target well to predict its future production performance. However, in the actual development process, the mine often requires the predicted production performance of the oil well before the oil well starts production, so as to optimize the fracturing design and well schedule.

Secondly, although the reservoir numerical simulation method can solve the above problem, it requires too much data and the modeling process is cumbersome. When there are many grids, the simulation speed is very slow and the calculation cost is high. In the subsequent optimization of the fracturing construction plan, it is necessary to run the reservoir numerical simulation software more than thousands times to estimate the production performances corresponding to different parameter combinations, which will consume a lot of manpower and resources.

### SUMMARY

An embodiment of the present disclosure provides a method for predicting a production performance of an oil reservoir. The method is efficient and fast, and can predict the production performance of a target well in an unconventional oil reservoir without the target well being put into production. The method includes:

acquiring geological parameters and rock and fluid parameters of an unconventional oil reservoir where a target well is located and construction data of a multi-stage fractured horizontal well, where the unconventional oil reservoir is a tight oil reservoir or a shale oil reservoir;

determining a single-well numerical simulation data set according to the geological parameters, the rock and fluid parameters and the construction data;

performing reservoir numerical simulation based on the single-well numerical simulation data set, and determining a standard data set for oil reservoir production performance prediction;

establishing a deep belief network (DBN) model for oil reservoir production performance prediction according to the standard data set; and

predicting the production performance of the target well by using the DBN model to obtain a production performance prediction result of the target well.

An embodiment of the present disclosure further provides a device for predicting a production performance of an oil reservoir. The device is efficient and fast, and can predict the production performance of a target well in an unconventional oil reservoir without the target well being put into production. The device includes:

a data acquisition module, for acquiring geological parameters and rock and fluid parameters of an unconventional oil reservoir where a target well is located and construction data of a multi-stage fractured horizontal well, where the unconventional oil reservoir is a tight oil reservoir or a shale oil reservoir;

a first data set module, for determining a single-well numerical simulation data set according to the geological parameters, the rock and fluid parameters and the construction data;

a second data set module, for performing reservoir numerical simulation based on the single-well numerical simulation data set, and determining a standard data set for oil reservoir production performance prediction;

a model establishment module, for establishing a DBN model for oil reservoir production performance prediction according to the standard data set; and

a prediction module, for predicting the production performance of the target well by using the DBN model to obtain a production performance prediction result of the target well.

An embodiment of the present disclosure further provides a computer device, including a memory, a processor and a computer program stored in the memory and executable on the processor, where when the processor executes the computer program, the above-mentioned method for predicting a production performance of an oil reservoir is implemented.

An embodiment of the present disclosure also provides a computer-readable storage medium, where the computer-readable storage medium stores a computer program for executing the above-mentioned method for predicting a production performance of an oil reservoir.

In overall, the embodiments of the present disclosure include: acquiring geological parameters and rock and fluid parameters of an unconventional oil reservoir where a target well is located and construction data of a multi-stage fractured horizontal well; determining a single-well numerical simulation data set according to the geological parameters, the rock and fluid parameters and the construction data; performing reservoir numerical simulation based on the single-well numerical simulation data set, and determining a standard data set for oil reservoir production performance prediction; and establishing a DBN model. The DBN model can be used to fast and accurately predict the production performance of an oil well in unconventional oil reservoirs in various situations. For a given block, the DBN model can be used indefinitely without the target well being put into production. While traditional reservoir numerical simulation methods take hours to days to predict the production performance of each well, the DBN model only requires a few seconds. Therefore, the present disclosure greatly shortens the time and improves the work efficiency for the optimization of fracturing design which requires production performance prediction and comparison of thousands of simulation schemes.

### BRIEF DESCRIPTION OF THE DRAWINGS

To describe the technical solutions in the embodiments of the present disclosure more clearly, the following briefly introduces the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a flowchart of a method for predicting a production performance of an oil reservoir according to an embodiment of the present disclosure.

FIG. 2 is a flowchart of a specific implementation process of Step 102 according to an embodiment of the present disclosure.

FIG. 3 is a flowchart of a specific implementation process of Step 103 according to an embodiment of the present disclosure.

FIG. 4 is a schematic diagram of a numerical simulation model for the production of a multi-stage fractured horizontal well in a tight oil reservoir according to a specific embodiment of the present disclosure.

FIGS. 5(a) and 5(b) are schematic diagrams showing influences of different activation function and dropout rates on a training effect of a deep belief network (DBN) model according to a specific embodiment of the present disclosure.

FIG. 6 is a schematic diagram showing a decline process of a loss function during a training process of the DBN model for predicting a cumulative oil production according to a specific embodiment of the present disclosure.

FIG. 7 is a schematic diagram showing a decline process of a loss function during a training process of the DBN model for predicting a daily oil production according to a specific embodiment of the present disclosure.

FIG. 8 is a comparison diagram of predicted and actual daily oil production and cumulative oil production according to a specific embodiment of the present disclosure.

FIG. 9 is a structural block diagram of a device for predicting a production performance of an oil reservoir according to an embodiment of the present disclosure.

FIG. 10 is a structural diagram of an electronic device for predicting a production performance of an oil reservoir according to an embodiment of the present disclosure.

### DETAILED DESCRIPTION

The technical solutions in the embodiments of the present disclosure are described clearly below with reference to the accompanying drawings in the embodiments of the present disclosure. Apparently, the described embodiments are merely a part rather than all of the embodiments of the present disclosure. All other embodiments derived from the embodiments of the present disclosure by a person of ordinary skill in the art without creative efforts should fall within the protection scope of the present disclosure.

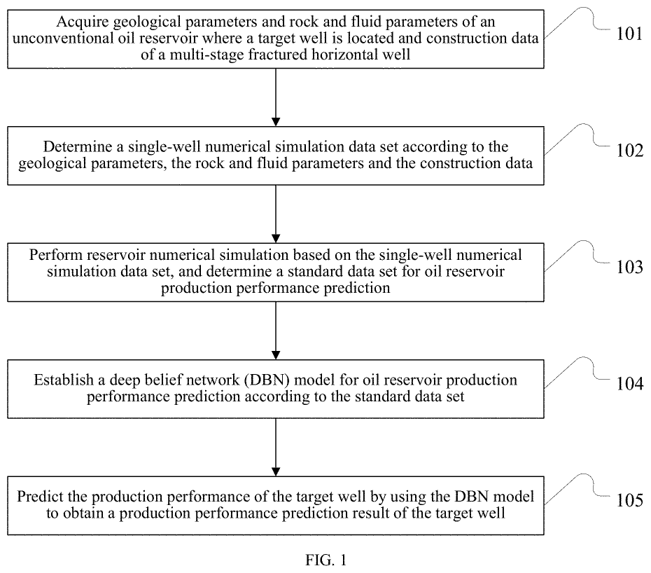

The present disclosure aims to solve the problems that the existing production performance prediction methods for unconventional oil (tight oil/shale oil) reservoirs require the target well to have been put into production and the numerical simulations require too much data and high calculation cost. An embodiment of the present disclosure provides a method for predicting a production performance of an oil reservoir. The method is efficient and fast, and can predict the production performance of a target well in an unconventional oil reservoir without the target well being put into production. As shown in FIG. 1, the method includes:

Step 101: Acquire geological parameters and rock and fluid parameters of an unconventional oil reservoir where a target well is located and construction data of a multi-stage fractured horizontal well.

Step 102: Determine a single-well numerical simulation data set according to the geological parameters, the rock and fluid parameters and the construction data.

Step 103: Perform reservoir numerical simulation based on the single-well numerical simulation data set, and determine a standard data set for oil reservoir production performance prediction.

Step 104: Establish a deep belief network (DBN) model for oil reservoir production performance prediction according to the standard data set.

Step 105: Predict the production performance of the target well by using the DBN model to obtain a production performance prediction result of the target well.

According to the flowchart shown in FIG. 1, the method in the embodiment of the present disclosure includes: acquire geological parameters and rock and fluid parameters of an unconventional oil reservoir where a target well is located and construction data of a multi-stage fractured horizontal well; determine a single-well numerical simulation data set according to the geological parameters, the rock and fluid parameters and the construction data; perform reservoir numerical simulation based on the single-well numerical simulation data set, and determine a standard data set for oil reservoir production performance prediction; and establish a DBN model. The DBN model can be used to fast and accurately predict the production performance of an oil well in unconventional oil reservoirs in various situations. For a given block, the DBN model can be used indefinitely without the target well being put into production. While traditional reservoir numerical simulation methods take hours to days to predict the production performance of each well, the DBN model only requires a few seconds. Therefore, the present disclosure greatly shortens the time and improves the work efficiency for the optimization of fracturing design which requires production performance prediction and comparison of thousands of simulation schemes.

In the specific implementation, the geological parameters and rock and fluid parameters of the unconventional oil reservoir where the target well is located and the construction data of the multi-stage fractured horizontal well are first acquired. In one embodiment, these data may be acquired from the geological exploration data, logging curves and other data of the target well, and the specific acquisition method may be determined according to the actual conditions, which is not limited in the present disclosure. In the embodiment of the present disclosure, the unconventional oil reservoir is a tight oil reservoir or a shale oil reservoir.

In the embodiment of the present disclosure, the geological parameters of the unconventional oil reservoir where the target well is located may be used to characterize the geological structure of the target well, and may include but not limited to one or any combination of the target well's contour maps regarding the structure, sand body thickness distribution, effective thickness distribution, porosity distribution and initial matrix permeability distribution, as well as the middle depth and the reservoir thickness.

In the embodiment of the present disclosure, the rock and fluid parameters of the unconventional oil reservoir where the target well is located may include but not limited to crude oil components, high-pressure physical properties of fluids, fluid viscosity, initial reservoir pressure, bubble point pressure, initial water saturation, relative permeability curve, nonlinear flow parameters and stress sensitivity of the matrix. The fluid viscosity includes one or any combination of crude oil viscosity, water viscosity and gas viscosity.

In the embodiment of the present disclosure, the construction data of the target well (multi-stage fractured horizontal well) may include but not limited to one or any combination of wellbore trajectory data, number of fracturing stages, fracture half-length, fracture aperture, fracture height and variation curves of fracture permeability and conductivity with effective stress. The horizontal well refers to a well whose inclination angle reaches or approaches 90° and wellbore is drilled in a certain length along the horizontal direction.

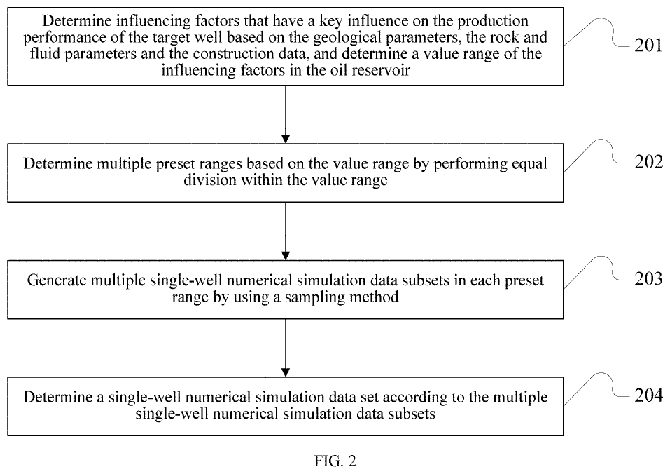

After the geological parameters and rock and fluid parameters of the unconventional oil reservoir and the construction data are acquired, the single-well numerical simulation data set is determined according to the geological parameters, the rock and fluid parameters and the construction data. As shown in FIG. 2, the specific process includes:

Step 201: Determine influencing factors that have a key influence on the production performance of the target well based on the geological parameters, the rock and fluid parameters and the construction data, and determine a value range of the influencing factors in the oil reservoir.

Step 202: Determine multiple preset ranges based on the value range by performing equal division within the value range.

Step 203: Generate multiple single-well numerical simulation data subsets in each preset range by using a sampling method.

Step 204: Determine a single-well numerical simulation data set according to the multiple single-well numerical simulation data subsets.

In the specific implementation of the present disclosure, the influencing factors include at least one or any combination of matrix permeability, natural fracture permeability, effective reservoir thickness, horizontal well length, bottom hole pressure, number of hydraulic fractures, stage spacing, fracture half-length, fracture aperture, fracture conductivity, fracturing fluid injection volume and shut-in time.

In an embodiment, in order to reasonably consider the variation range of these influencing factors in the actual oil reservoir, Step 202 may specifically divide the value range into five equal parts to obtain five preset ranges. In the specific implementation of Step 203, single-well numerical simulation schemes are established within each preset range according to the selected influencing factors by using a sampling method, and multiple single-well numerical simulation data subsets are generated. The single-well numerical simulation schemes refer to multiple sets of numerical simulation schemes constructed by taking different values of the selected influencing factors to consider the influences of the selected influencing factors on the production performance of the target well when the parameters other than the selected influencing factors are set as typical parameters of the unconventional oil reservoir where the target well is located, where the number of the selected influencing factors may be arbitrary. The single well means that only one multi-stage fractured horizontal well is set during the numerical simulation. By randomly selecting from the preset range by using a sampling method for multiple times, a large number of numerical simulation schemes are derived, and multiple single-well numerical simulation data subsets are generated. One single-well numerical simulation scheme corresponds to one single-well numerical simulation data subset. Multiple single-well numerical simulation data subsets are assembled together to form a single-well numerical simulation data set.

The sampling method may include but not limited to Monte Carlo method, acceptance-rejection sampling and Gibbs sampling which are suitable for different parameter distributions of the unconventional oil reservoir. In the specific implementation process, the optimization algorithm may be selected according to the characteristics of the optimization problem, which is not limited in the present disclosure.

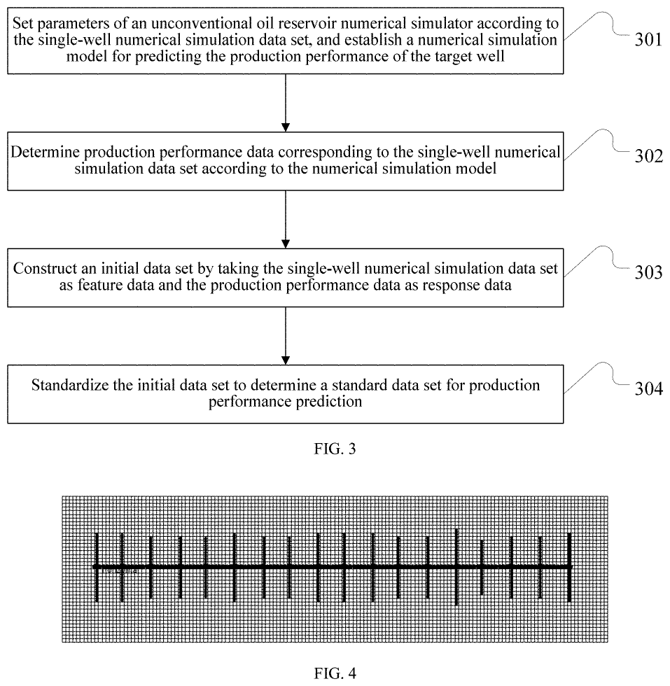

After the single-well numerical simulation data set is determined, the reservoir numerical simulation is performed based on the single-well numerical simulation data set, and a standard data set for oil reservoir production performance prediction is determined. As shown in FIG. 3, the specific process includes:

Step 301: Set parameters of an unconventional oil reservoir numerical simulator according to the single-well numerical simulation data set, and establish a numerical simulation model for predicting the production performance of the target well.

Step 302: Determine production performance data corresponding to the single-well numerical simulation data set according to the numerical simulation model.

Step 303: Construct an initial data set by taking the single-well numerical simulation data set as feature data and the production performance data as response data.

Step 304: Standardize the initial data set to determine a standard data set for production performance prediction.

The numerical simulation model used to simulate the production of the target well is a mathematical model that uses a computer to solve the production of the target well. It can be used to simulate the flow of underground oil and water and provide the distribution of oil and water at a certain time to predict the production performance (such as oil production) of the oil reservoir.

In the specific implementation process of Step 301, a conceptual geological model of the unconventional oil reservoir may be established based on the geological parameters corresponding to different single-well numerical simulation data subsets in the single-well numerical simulation data set, and imported into the unconventional oil reservoir numerical simulator. The parameter values in the unconventional oil reservoir numerical simulator are set according to the rock and fluid parameters of the unconventional oil reservoir, and the data of the multi-stage fractured horizontal well are input into the unconventional oil reservoir numerical simulator. In this way, the numerical simulation model is established.

In the embodiment of the present disclosure, the numerical simulation of the unconventional oil reservoir may include, for example, establish a mathematical model, establish a numerical model and establish a computer model. The establishing a mathematical model is mainly to establish partial differential equations of fluid flow in the tight oil reservoir according to the law of conservation of mass, and combine the equations with corresponding auxiliary equations and definite conditions (initial conditions, boundary conditions) to form a complete mathematical model. In establishing the mathematical model, factors such as the nonlinear flow mechanism of the tight reservoir, the stress-sensitivity of the matrix and the dynamic closure of hydraulic fractures may be taken into consideration to make the optimization results more accurate and make the predicted cumulative oil production truly reflect the production performance of the actual oil reservoir.

In a specific embodiment, the establishing a numerical model may include: (1) discretization, to convert continuous partial differential equations into discrete finite difference equations; (2) linearization: to linearize nonlinear coefficient items in the finite difference equations to obtain linear algebraic equations; and (3) solve the linear algebraic equations by using a method which may include but not limited to direct solution method and iterative solution method. Further, a computer model may be established, which is to compile the numerical solution process of the mathematical model into a computer program, so that the results can be obtained through rapid computer simulation. The computer model may include but not limited to at least one of data input, equations construction, equations solution and result output. The computer program may be called an unconventional oil reservoir numerical simulator or unconventional oil reservoir numerical simulation software.

In a specific embodiment, the production performance data may include, for example, daily oil production and cumulative oil production data within a preset time period. The preset time period may be expressed by any value greater than 0 in the unit of year, month, day, hour, minute or second, and may be specifically determined according to the actual conditions, which is not limited in the present disclosure. For example, if it is needed to predict the production performance of the target well in 10 years, the corresponding preset time period is 10 years.

In an embodiment, the specific implementation process of Step 304 includes:

Delete abnormal and missing values in the initial data set that do not match the actual oil reservoir.

Transform feature data in the initial data set after the deletion into a distribution in a range of 0 to 1 by using a min-max normalization method.

Construct the standard data set according to the transformed feature data and the response data.

The abnormal and missing values refer to abnormal and missing data in the initial data set due to the inconsistency with actual production and the inability to perform numerical simulation. The method used in the standardization is min-max normalization, which transforms the feature data in the initial data set after deletion to a value between 0 and 1, so as to avoid problems such as difficulty in algorithm convergence caused by differences in different feature calculation equations.

After the standard data set for oil reservoir production performance prediction is determined, the DBN model for oil reservoir production performance prediction is established according to the standard data set. The specific process includes: train the DBN model to determine the weights and biases within this model by taking the feature data in the standard data set as an input into the DBN model and the response data in the standard data set as an output from the DBN model, so as to generate the DBN model for oil reservoir production performance prediction.

After the DBN model for oil reservoir production performance prediction is generated, the production performance of the target well is predicted by using the DBN model to obtain a production performance prediction result of the target well. The specific implementation includes: acquire the feature data of the target well, and input the feature data of the target well into the trained DBN model to obtain a production performance prediction result of the target well.

In order to obtain a hyper-parameter combination that optimizes the training effect and efficiency of the DBN model, in a specific embodiment, a Bayesian optimization algorithm and a k-fold cross validation method may be used to optimize hyper-parameters of the DBN model to obtain the DBN model under the optimal hyper-parameter configuration. The hyper-parameters of the DBN model refer to the structure and training parameters that need to be manually set before the machine learning (ML) model is trained.

In the specific implementation process, the hyper-parameters of the DBN model are optimized by the combination of the Bayesian optimization algorithm and the k-fold cross validation method, to obtain the DBN model under the optimal hyper-parameter configuration. The hyper-parameters that need to be optimized include the number of hidden layers of the DBN model, the number of hidden layer neurons, learning rate, number of iterations, batch size, dropout rate, activation function and other parameters. For different unconventional oil reservoirs, different hyper-parameters need to be set, and the setting of hyper-parameters will directly affect the training and prediction effects and speeds of the DBN model.

In the specific implementation process, optimizing the hyper-parameters of the DBN model may require an initial hyper-parameter combination determined through manual adjustment. The model is set according to the initial hyper-parameter combination, and a comprehensive performance evaluation index for the prediction effect of the DBN model may be calculated by the k-fold cross validation method. The evaluation index may be but not limited to any of the following: coefficient of determination (R²), root mean square (RMS), root mean square error (RMSE) and mean absolute error (MAE). The appropriate comprehensive performance evaluation index may be selected according to the actual prediction requirement, which is not limited in the present disclosure.

Further, according to the comprehensive evaluation index obtained by the calculation, select another hyper-parameter combination. Repeat the training process, calculate the new comprehensive performance evaluation index using the k-fold cross validation method and record the result each time. The newly acquired comprehensive performance evaluation index is compared with all the comprehensive performance evaluation indexes in the record to determine a possible distribution space of optimal hyper-parameters. According to the possible distribution space of optimal hyper-parameters, a new hyper-parameter combination is selected. The training is repeated, and a new comprehensive performance evaluation index is obtained and compared. This process is continued until a preset number of times or a preset termination condition is reached. The set of hyper-parameters corresponding to the best comprehensive performance evaluation indexes obtained is the optimal hyper-parameters of the DBN model. The preset number of times may be 100, and the preset termination condition may be a ratio of two consecutive optimization results to the recorded optimal results being less than 0.1%. In actual applications, the preset number of times and the preset termination condition may be determined according to the required optimization effect, which is not limited in the present disclosure.

A specific embodiment is given below to illustrate how the embodiment of the present disclosure performs reservoir production performance prediction. It is worth noting that the specific embodiment is merely intended to better describe the present disclosure, rather than to constitute an improper limitation to the present disclosure.

Step S1: Acquire geological parameters of and rock and fluid parameters of a tight oil reservoir and construction data of a multi-stage fractured horizontal well. The basic physical parameters of the oil reservoir (including the geological parameters and rock and fluid parameters of the tight oil reservoir) are shown in Table 1, and the crude oil component parameters are shown in Table 2.

TABLE 1
Basic physical parameters of oil reservoir

| Parameter | Unit | Value |
|---|---|---|
| Model grid number | — | 320 × 80 × 1 |
| Model size | m | 3200 × 500 × 15 |
| Reservoir temperature | ° C. | 118.33 |
| Reservoir pressure | kPa | 53779 |
| Reservoir thickness | m | 15 |
| Matrix porosity | — | 5% |
| Matrix permeability | 10⁻³ μm² | 0.05 |
| Compressibility | 1/kPa | 1.45 × 10⁻⁷ |
| Initial water saturation | — | 25% |

TABLE 2
Component parameters of tight oil reservoir

| | Mole | Critical | Critical | Molar | Critical | Acentric |
|---|---|---|---|---|---|---|
| Component | fraction | temperature/K | pressure/atm | mass/(g/gmol) | volume/(L/mol) | factor |
| CO₂ | 0.0118 | 204.20 | 72.80 | 44.01 | 0.0940 | 0.2250 |
| N₂—C₁ | 0.0016 | 126.20 | 33.50 | 28.01 | 0.0895 | 0.0400 |
| C₂-C₄ | 0.2454 | 190.60 | 45.40 | 16.04 | 0.0990 | 0.0080 |
| C₅-C₇ | 0.2445 | 371.46 | 41.92 | 44.79 | 0.2039 | 0.1481 |
| C₈-C₁₂ | 0.1892 | 504.94 | 33.11 | 83.87 | 0.3367 | 0.2526 |
| C₁₃-C₁₉ | 0.2215 | 709.72 | 27.91 | 120.54 | 0.4567 | 0.3294 |
| C₂₀-C₃₀ | 0.0860 | 986.86 | 20.73 | 297.27 | 0.9700 | 0.07532 |

Step S2: Select influencing factors of the production performance of the tight oil reservoir, and determine a single-well numerical simulation data set.

According to the acquired geological parameters and rock fluid parameters of the tight oil reservoir and the construction data of the multi-stage fractured horizontal well, the influences of different factors on oilfield production are analyzed, and 12 influencing factors with significant influences on the production performance are selected. These influencing factors are divided into geological factors of the tight oil reservoir and engineering factors in fracturing and production. Each influencing factor is called a feature of the scheme, and the selected influencing factors and their units are shown in Table 3.

TABLE 3
Selected influencing factors and their units

| Influencing factor | Unit |
|---|---|
| Horizontal well length | m |
| Total number of hydraulic fractures | — |
| Stage spacing | m |
| Fracture conductivity | μm² · cm |
| Fracture aperture | m |
| Fracture half-length | m |
| Matrix permeability | 10⁻³ μm² |
| Natural fracture permeability | 10⁻³ μm² |
| Reservoir thickness | m |
| Bottom hole pressure | MPa |
| Daily injection volume of fracturing fluid | m³/day |
| Shut-in time after fracturing | day |

In the actual tight oil reservoir, each influencing factor has a different range of variation. Therefore, according to the maximum and minimum of each influencing factor, five different preset ranges are selected within the range formed by the maximum and minimum. The first and last preset ranges respectively correspond to the minimum and maximum values of each influencing factor. The specific preset ranges of each influencing factor are shown in Table 4.

TABLE 4
Selection of the preset ranges of each influencing factor

| | Number | |
|---|---|---|
| | of preset | |
| Influencing factor | ranges | Preset range |
| Horizontal well length | 5 | 1000, 1500, 2000, 2500, 3000 |
| Total number of | 5 | 8, 20, 40, 48, 60 |
| fractures | | |
| Stage spacing | 5 | 40, 50, 60, 70, 80 |
| Fracture conductivity | 5 | 15, 75, 150, 750, 1500 |
| Fracture aperture | 5 | 0.0025, 0.003, 0.0035, 0.004, 0.0045 |
| Fracture half-length | 5 | 50, 75, 100, 125, 150 |
| Matrix permeability | 5 | 0.01, 0.03, 0.05, 0.08, 0.1 |
| Natural fracture | 5 | 0.1, 0.2, 0.3, 0.4, 0.5 |
| permeability | | |
| Reservoir thickness | 5 | 12, 15, 18, 21, 24 |
| Bottom hole pressure | 5 | 9, 13, 17, 21, 25 |
| Daily injection | 5 | 5000, 7500, 10000, 12500, 15000 |
| volume of | | |
| fracturing fluid | | |
| Shut-in time after | 5 | 15, 30, 45, 60, 75 |
| fracturing | | |

When constructing a single-well numerical simulation scheme, it is necessary to randomly select one of the five preset ranges of each influencing factor through the Monte Carlo method. Each set of single-well numerical simulation schemes contain values of the 12 features. The sampling is repeated 1,000 times to form 1,000 sets of single-well numerical simulation schemes and 1,000 single-well numerical simulation data subsets. For the target block, these schemes cover all possible ranges of geological and engineering parameters in the actual tight oil reservoir development, which ensures the wide applicability of the method of the present disclosure.

Step S3: Perform reservoir numerical simulation based on the single-well numerical simulation data set, and determine a standard data set for oil reservoir production performance prediction.

A conceptual geological model of the tight oil reservoir is established based on the geological parameters corresponding to different single-well numerical simulation data subsets in the single-well numerical simulation data set. The rock and fluid parameters are set in the conceptual geological model, and the data of each stage of the fractured horizontal well are input to establish a numerical simulation model for the production of the multi-stage fractured horizontal well in the tight oil reservoir, as shown in FIG. 4.

Further, the corresponding parameters in the numerical simulation model are set according to the values of different features in the numerical simulation scheme, and the production is simulated through the tight reservoir numerical simulator to obtain a 20-year depletion production performance curve of the tight oil reservoir, including daily oil production and cumulative oil production data. The output data serve as the response data of the corresponding numerical simulation scheme. The parameter changes and production simulation of the numerical simulation model are carried out according to each numerical simulation scheme, and the response data corresponds to the feature data one-to-one to form an initial data set for predicting the development and production performance of the tight oil reservoir.

The initial data set is standardized to reduce the impact of data structure problems on the model training effect, and form a standard data set for predicting the production performance of the tight oil reservoir. First, samples with missing response data in the initial data set are deleted. The random sampling may result in schemes that do not conform to the actual tight oil reservoir, and the corresponding numerical simulations will have no output, thus causing missing response data. The min-max normalization method is used to process the feature data of the initial data set after deletion. The min-max normalization method is to transform the data of each feature into a range of 0 to 1, which avoids problems such as difficulty in model convergence caused by the large differences of different feature dimensions. The min-max normalization of the feature data is as follows:

$${x}^{*} = \frac{x - {x}_{min}}{{x}_{max}}$$

In the equation, x represents an original feature data, xₘᵢₙ represents a minimum value of the feature data, xₘₐₓ represents a maximum value of the feature data, and x* represents a normalized feature data.

Step S4: Establish a DBN model, and optimize hyper-parameters in the model.

The DBN model is generated by training based on the preprocessed standard data set, and hyper-parameters of the DBN model are optimized. The hyper-parameters of the ML model refer to the parameters that need to be artificially set, such as the structure and the learning rate of the model, which have a key influence on the training effect of the model. The optimization of the hyper-parameters in the DBN model mainly uses a combination of manual adjustment and automatic adjustment by using the Bayesian optimization algorithm. A comprehensive evaluation index is set to optimize the hyper-parameters. When the comprehensive evaluation index reaches the maximum, the prediction effect of the model is the best. The coefficient of determination R² is selected as the comprehensive evaluation index, which is calculated as follows:

$${R}^{2} = \frac{{\sum }_{i = 1}^{n} {( {\hat{y}}_{i} - \overline{y} )}^{2}}{{\sum }_{i = 1}^{n} {( {y}_{i} - \overline{y} )}^{2}}$$

In the equation, R² represents the coefficient of determination, Y, represents a value of the response data predicted by the DBN model, Y, represents an actual value of the response data, Y represents an average of the response data, and n represents the total number of samples.

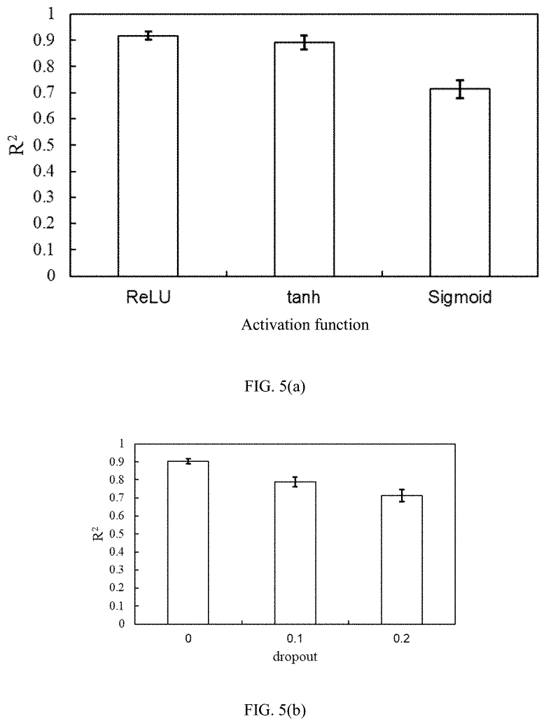

The response data in the standard data set are divided into two parts: daily oil production and cumulative oil production. Taking the cumulative oil production as an example, the activation function and the dropout rate of the DBN model are first determined through manual adjustment. The activation function of the model is set to sigmoid, hyperbolic tangent tanh and rectified linear unit ReLU function and the dropout rate is set to 0, 0.1 and 0.2. The standard data set is randomly divided into a training set and a test set according to a ratio of 8:2. The training set is used to train the model, and the test set is used to examine the model effect. The current coefficient of determination of the model is calculated and the coefficients of determination in different situations are compared. The comparison is shown in FIGS. 5(a) and 5(b). It is finally determined that the model uses the ReLU function as the activation function and the dropout rate is 0.

Manual adjustment is performed to determine the range of optimal hyper-parameters and select initial values of Bayesian optimization. The parameters of the DBN model that need to be automatically adjusted as well as the optimization spaces and initial values are shown in Table 5. The domain space of the Bayesian optimization algorithm is set according to the optimization spaces, and the number of optimization iterations is set to 100. An initial hyper-parameter combination Q₀ is selected to set the DBN model, and the coefficient of determination R₀ under the current hyper-parameter value is calculated by using a 10-fold cross validation method.

TABLE 5
Hyper-parameter optimization space and initial value

| | Optimization | Initial |
|---|---|---|
| Hyper-parameter | space | value |
| Number of hidden layer neurons | 50-300 | 200 |
| Restricted Boltzmann machine | 0.01-0.1 | 0.02 |
| (RBM) learning rate | | |
| Total learning rate | 0.01-0.1 | 0.02 |
| RBM number of iterations | 5-30 | 15 |
| Training period | 50-500 | 300 |
| Batch size | 1-15 | 7 |

Specifically, the 10-fold cross validation method includes: randomly divide the sample set into 10 equal parts; use the first part as the test set and the remaining 9 parts as the training set to train the DBN model; take the feature data of the test set as the input into the trained model, compare the obtained output data with the response data of the test set, and calculate a coefficient of determination R₀₁; then select the second part of data as the test set and the remaining 9 parts as the training set to train and calculate a coefficient of determination R₀₂; repeat the training and calculation process 10 times in total to obtain 10 different coefficients of determination R₀₁, R₀₂, . . . , R₀₁₀; and take an average of these 10 coefficients of determination to obtain the value of the coefficient of determination R₀, that is, the comprehensive evaluation index under the current hyper-parameter combination Q₀, and record the value in set R*, where R* is:

R*={R₀,R₁, . . . ,Rₖ}

where, Rₖ is the coefficient of determination of the model under a hyper-parameter combination in a k-th iteration, and k is the number of steps performed in the current optimization iteration.

Further, according to the values of the coefficient of determination in R* and the corresponding values of the hyper-parameters, a hyper-parameter combination Q₁ for the next iteration is determined. The hyper-parameter combination is set in the DBN model and the cross validation process is repeated to obtain a corresponding coefficient of determination R₁ to update R*. Similarly, the above process is repeated. The appropriate hyper-parameter combination is selected according to R*, and the corresponding coefficient of determination is calculated. The optimization process is ended when the number of repeated iterations reaches the preset maximum number of iterations. The largest coefficient of determination is selected from R*, and the corresponding hyper-parameter combination is the optimal hyper-parameters of the DBN model under the current data. The same optimization process is performed for daily oil production, and the finally determined optimal hyper-parameter combinations of the daily oil production and cumulative oil production are shown in Table 6.

TABLE 6
Optimal hyper-parameter combination

| | Optimal value | Optimal value |
|---|---|---|
| | for daily | for cumulative |
| Hyper-parameter | oil production | oil production |
| Number of hidden layer neurons | 155 | 185 |
| RBM learning rate | 0.02 | 0.08 |
| Total learning rate | 0.02 | 0.02 |
| RBM number of iterations | 16 | 28 |
| Number of training epochs | 260 | 350 |
| Batch size | 7 | 7 |

Step S5: Train the DBN model under the optimal configuration, and predict the production performance of the target well using the trained model.

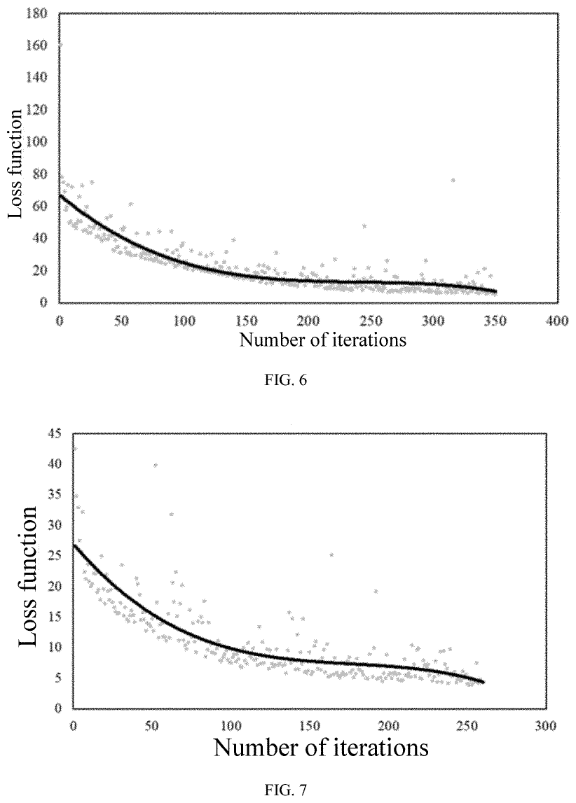

According to the optimal hyper-parameter combinations of the cumulative oil production and the daily oil production, the DBN model is set respectively and trained using the standard data set. FIGS. 6 and 7 respectively show a decline process of a loss function of a cumulative oil production prediction model and a loss function of a daily oil production prediction model during the training process. The loss function reaches the minimum when the training iterations reach a certain number of times.

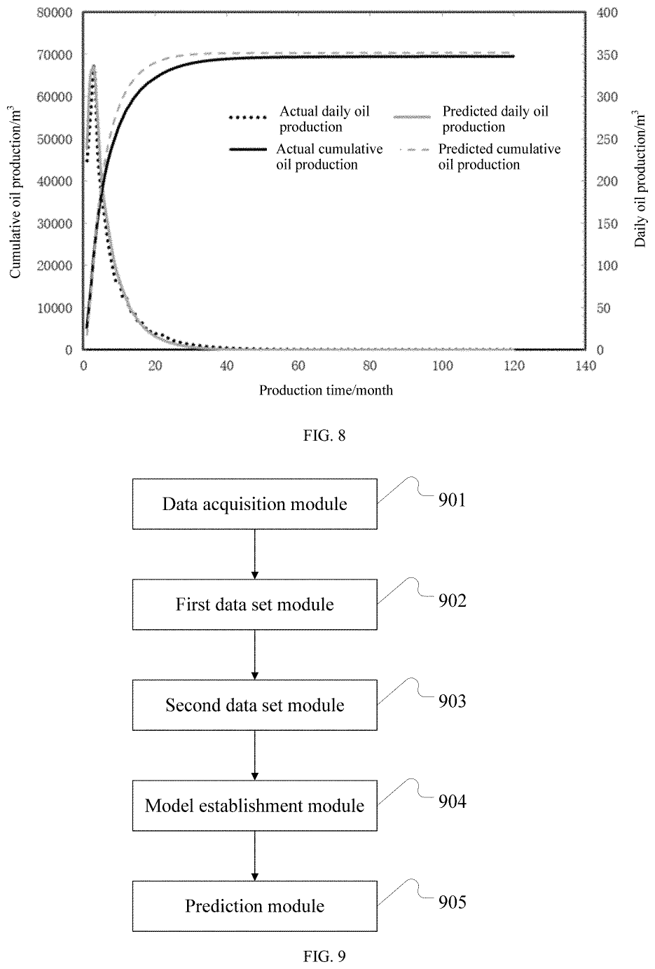

Further, the feature data of the target well and the feature data in the standard data set are processed in the same manner, and input into the trained prediction models to obtain a predicted cumulative oil production and a predicted daily oil production. A case not considered in the training process is selected to predict and justify the prediction effect of the models. The comparison between the predicted and actual cumulative oil production and daily oil production is shown in FIG. 8. The prediction indexes of the models are shown in Table 7, which shows that the models have a good prediction effect. It is understandable that, for the case in an actual oil reservoir, the prediction curve shown in FIG. 8 is the final production performance prediction data of the target well.

TABLE 7
Prediction indexes in an actual case

| | Prediction index | | |
|---|---|---|---|
| Prediction type | R² | MSE | MAE |
| Daily oil production | 0.9332 | 16.44 | 4.31 |
| Cumulative oil production | 0.9548 | 60.72 | 7.79 |

Based on the same inventive concept, an embodiment of the present disclosure further provides a device for predicting a production performance of an oil reservoir. Since the principle of the problem to be solved by the reservoir production performance prediction device is similar to that by the reservoir production performance prediction method, the implementation of the reservoir production performance prediction device may refer to the implementation of the reservoir production performance prediction method, and will not be repeated here. As shown in FIG. 9, the reservoir production performance prediction device specifically includes: a data acquisition module 901, a first data set module 902, a second data set module 903, a model establishment module 904 and a prediction module 905.

The data acquisition module 901 is used to acquire geological parameters and rock and fluid parameters of an unconventional oil reservoir where a target well is located and construction data of a multi-stage fractured horizontal well, where the unconventional oil reservoir is a tight oil reservoir or a shale oil reservoir.

The first data set module 902 is used to determine a single-well numerical simulation data set according to the geological parameters, the rock and fluid parameters and the construction data.

The second data set module 903 is used to perform reservoir numerical simulation based on the single-well numerical simulation data set, and determine a standard data set for oil reservoir production performance prediction.

The model establishment module 904 is used to establish a DBN model for oil reservoir production performance prediction according to the standard data set.

The prediction module 905 is used to predict the production performance of the target well by using the DBN model to obtain a production performance prediction result of the target well.

In a specific embodiment, the first data set module 902 is specifically used to:

Determine influencing factors that have a key influence on the production performance of the target well based on the geological parameters, the rock and fluid parameters and the construction data, and determine a value range of the influencing factors in the oil reservoir.

Determine multiple preset ranges based on the value range by performing equal division within the value range.

Generate multiple single-well numerical simulation data subsets in each preset range by using a sampling method.

Determine a single-well numerical simulation data set according to the multiple single-well numerical simulation data subsets.

In a specific embodiment, the second data set module 903 is specifically used to:

Set parameters of an unconventional oil reservoir numerical simulator according to the single-well numerical simulation data set, and establish a numerical simulation model for predicting the production performance of the target well.

Determine production performance data corresponding to the single-well numerical simulation data set according to the numerical simulation model.

Construct an initial data set by taking the single-well numerical simulation data set as feature data and the production performance data as response data.

Standardize the initial data set to determine a standard data set for production performance prediction.

In a specific embodiment, the model establishment module 904 is specifically used to generate a DBN model for oil reservoir production performance prediction by training by taking the feature data in the standard data set as an input into the DBN model and the response data in the standard data set as an output from the DBN model.

In a specific embodiment, the prediction module 905 is specifically used to acquire the feature data of the target well, and input the feature data of the target well into the trained DBN model to obtain a production performance prediction result of the target well.

An embodiment of the present disclosure further provides a computer device, including a memory, a processor and a computer program stored in the memory and executable on the processor, where when the processor executes the computer program, the above-mentioned method for predicting a production performance of an oil reservoir is implemented.

An embodiment of the present disclosure further provides a computer-readable storage medium, where the computer-readable storage medium stores a computer program for executing the above-mentioned method for predicting a production performance of an oil reservoir.

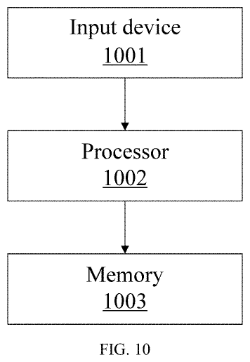

An embodiment of the present disclosure further provides an electronic device. For details, please refer to FIG. 10, which shows a structural diagram of the electronic device for predicting a production performance of an oil reservoir according to an embodiment of the present disclosure. The electronic device may specifically include an input device 1001, a processor 1002 and a memory 1003. The input device 1001 may be specifically used to input geological parameters and rock and fluid parameters of an unconventional oil reservoir where a target well is located and construction data of a multi-stage fractured horizontal well. The processor 1002 may be specifically used to determine a single-well numerical simulation data set according to the geological parameters, the rock and fluid parameters and the construction data of the multi-stage fractured horizontal well; perform reservoir numerical simulation based on the single-well numerical simulation data set, and determine a standard data set for oil reservoir production performance prediction; establish a DBN model for oil reservoir production performance prediction according to the standard data set; and predict the production performance of the target well by using the DBN model to obtain a production performance prediction result of the target well. The memory 1003 may be specifically used to store the geological parameters and rock and fluid parameters of the unconventional oil reservoir where the target well is located, the data of the multi-stage fractured horizontal well, prediction results and other parameters.

In this implementation, the input device may specifically be one of main devices for information exchange between a user and a computer system. The input device may include a keyboard, a mouse, a camera, a scanner, a light pen, a handwriting input board and a voice input device. The input device is used to input raw data and a program for processing the data into a computer. The input device may also be used to acquire and receive data transmitted from other modules, units and devices. The processor may be implemented in any suitable way. For example, the processor may be a microprocessor or processor, or a computer-readable medium, a logic gate, a switch, an application specific integrated circuit (ASIC), a programmable logic controller or an embedded microcontroller that stores computer-readable program codes (such as software or firmware) executable by the microprocessor or processor. The memory may specifically be a storage device used to store information in modern information technology. The memory may be understood in a broad sense. In a digital system, the memory may be any device that is able to store binary data. In the integrated circuit field, the memory may be a circuit which has no physical form but has a storage function, for example, a read-only memory (RAM) or a first-in-first out (FIFO) memory. In a system, the memory may be a storage device with physical form, such as a memory bank or a TransFlash (TF) card.

In this embodiment, the specific functions and effects implemented by the electronic device may be explained with reference to other embodiments, which will not be repeated here.

In summary, the method and device for predicting a production performance of an oil reservoir according to the embodiments of the present disclosure have the follow advantages:

The embodiments of the present disclosure include: acquire geological parameters and rock and fluid parameters of an unconventional oil reservoir where a target well is located and construction data of a multi-stage fractured horizontal well; determine a single-well numerical simulation data set according to the geological parameters, the rock and fluid parameters and the construction data; perform reservoir numerical simulation based on the single-well numerical simulation data set, and determine a standard data set for oil reservoir production performance prediction; and establish a DBN model. The DBN model can be used to fast and accurately predict the production performance of an oil well in unconventional oil reservoirs in various situations. The present disclosure determines the single-well numerical simulation data set by selecting influencing factors that have a key influence on the production performance of the target well. Thus, the data used in the further training of the DBN model fully consider the development characteristics and key influencing factors of the unconventional oil reservoir, improving the accuracy and scope of application of the prediction device and method. For a given block, the DBN model can be used indefinitely without the target well being put into production. While traditional reservoir numerical simulation methods take hours to days to predict the production performance of each well, the DBN model only requires a few seconds. Therefore, the present disclosure greatly shortens the time and improves the work efficiency for the optimization of fracturing design which requires production performance prediction and comparison of thousands of simulation schemes. In addition, the models consider the fracturing process parameters and the well schedule, which is conducive to rationally optimizing fracturing design and the production plan of the oil well, and provides guidance for the efficient development of tight oil/shale oil.

Persons skilled in the art should understand that the embodiments of the present disclosure may be provided as a method, a device or a computer program product. Therefore, the present disclosure may be described with reference to hardware only embodiments, software only embodiments or embodiments with a combination of software and hardware. The present disclosure may also be described with reference to a computer program product that is implemented on one or more computer storage media (including but not limited to a disk memory, compact disc read-only memory (CD-ROM) and an optical memory) that include computer program codes.

The present disclosure is described with reference to the flowcharts and/or block diagrams of the method, the device and the computer program product according to the embodiments of the present disclosure. It should be understood that computer program instructions may be used to implement each process and/or each block in the flowcharts and/or the block diagrams and a combination of a process and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate a device for implementing a specific function in one or more processes in the flowcharts and/or in one or more blocks in the block diagrams.

These computer program instructions may also be stored in a computer-readable memory that can instruct the computer or any other programmable data processing device to work in a specific manner, so that the instructions stored in the computer-readable memory generate an artifact that includes an instruction device. The instruction device implements a specific function in one or more processes in the flowcharts and/or in one or more blocks in the block diagrams.

These computer program instructions may also be loaded onto a computer or another programmable data processing device, so that a series of operations and steps are performed on the computer or other programmable device, thereby generating computer-implemented processing. Therefore, the instructions executed on the computer or other programmable device provide steps for implementing a specific function in one or more processes in the flowcharts and/or in one or more blocks in the block diagrams.

The above described are merely the preferred embodiments of the present disclosure, and are not intended to limit the present disclosure. Various changes and modifications may be made to the embodiments of the present disclosure by those skilled in the art. Any modifications, equivalent substitutions and improvements made within the spirit and scope of the present disclosure should be included within the protection scope of the present disclosure.

What is claimed is:

1. A method for predicting a production performance of an oil reservoir, comprising:
acquiring geological parameters and rock and fluid parameters of an unconventional oil reservoir where a target well is located and construction data of a multi-stage fractured horizontal well, wherein the unconventional oil reservoir is a tight oil reservoir or a shale oil reservoir;
determining a single-well numerical simulation data set according to the geological parameters, the rock and fluid parameters and the construction data;
performing reservoir numerical simulation based on the single-well numerical simulation data set, and determining a standard data set for oil reservoir production performance prediction;
establishing a deep belief network (DBN) model for oil reservoir production performance prediction according to the standard data set; and
predicting the production performance of the target well by using the DBN model to obtain a production performance prediction result of the target well.

2. The method according to claim 1, wherein the determining a single-well numerical simulation data set according to the geological parameters, the rock and fluid parameters and the construction data comprises:
determining influencing factors that have a key influence on the production performance of the target well based on the geological parameters, the rock and fluid parameters and the construction data, and determining a value range of the influencing factors in the oil reservoir;
determining multiple preset ranges based on the value range by performing equal division within the value range;
generating multiple single-well numerical simulation data subsets in each preset range by using a sampling method; and
determining a single-well numerical simulation data set according to the multiple single-well numerical simulation data subsets.

3. The method according to claim 2, wherein the influencing factors comprise at least:
one or any combination of matrix permeability, natural fracture permeability, effective reservoir thickness, horizontal well length, bottom hole pressure, number of hydraulic fractures, stage spacing, fracture half-length, fracture aperture, fracture conductivity, fracturing fluid injection volume and shut-in time.

4. The method according to claim 1, wherein the performing reservoir numerical simulation based on the single-well numerical simulation data set, and determining a standard data set for oil reservoir production performance prediction comprises:
setting parameters of an unconventional oil reservoir numerical simulator according to the single-well numerical simulation data set, and establishing a numerical simulation model for predicting the production performance of the target well;
determining production performance data corresponding to the single-well numerical simulation data set according to the numerical simulation model;
constructing an initial data set by taking the single-well numerical simulation data set as feature data and the production performance data as response data; and
standardizing the initial data set, and determining a standard data set for production performance prediction.

5. The method according to claim 4, wherein the standardizing the initial data set, and determining a standard data set for production performance prediction comprises:
deleting abnormal and missing values in the initial data set that do not match the actual oil reservoir;
transforming feature data in the initial data set after the deletion into a distribution in a range of 0 to 1 by using a min-max normalization method; and
constructing the standard data set according to the transformed feature data and the response data.

6. The method according to claim 4, wherein the establishing a DBN model for oil reservoir production performance prediction according to the standard data set comprises:
generating a DBN model for oil reservoir production performance prediction by training by taking the feature data in the standard data set as an input into the DBN model and the response data in the standard data set as an output from the DBN model.

7. The method according to claim 5, wherein the establishing a DBN model for oil reservoir production performance prediction according to the standard data set comprises:
generating a DBN model for oil reservoir production performance prediction by training by taking the feature data in the standard data set as an input into the DBN model and the response data in the standard data set as an output from the DBN model.

8. The method according to claim 6, further comprising:
optimizing hyper-parameters of the DBN model by using a Bayesian optimization algorithm and a k-fold cross validation method, to obtain the DBN model under the optimal hyper-parameter configuration.

9. The method according to claim 7, further comprising:
optimizing hyper-parameters of the DBN model by using a Bayesian optimization algorithm and a k-fold cross validation method, to obtain the DBN model under the optimal hyper-parameter configuration.

10. The method according to claim 6, wherein the predicting the production performance of the target well by using the DBN model to obtain a production performance prediction result of the target well comprises:
acquiring the feature data of the target well; and
inputting the feature data of the target well into the trained DBN model to obtain a production performance prediction result of the target well.

11. The method according to claim 7, wherein the predicting the production performance of the target well by using the DBN model to obtain a production performance prediction result of the target well comprises:
acquiring the feature data of the target well; and
inputting the feature data of the target well into the trained DBN model to obtain a production performance prediction result of the target well.

12. A device for predicting a production performance of an oil reservoir, comprising:
a data acquisition module, for acquiring geological parameters and rock and fluid parameters of an unconventional oil reservoir where a target well is located and construction data of a multi-stage fractured horizontal well, wherein the unconventional oil reservoir is a tight oil reservoir or a shale oil reservoir;
a first data set module, for determining a single-well numerical simulation data set according to the geological parameters, the rock and fluid parameters and the construction data;
a second data set module, for performing reservoir numerical simulation based on the single-well numerical simulation data set, and determining a standard data set for oil reservoir production performance prediction;
a model establishment module, for establishing a DBN model for oil reservoir production performance prediction according to the standard data set; and
a prediction module, for predicting the production performance of the target well by using the DBN model to obtain a production performance prediction result of the target well.

13. A computer device, comprising a memory, a processor and a computer program stored in the memory and executable on the processor, wherein when the processor executes the computer program, the method according to claim 1 is implemented.

14. A computer device, comprising a memory, a processor and a computer program stored in the memory and executable on the processor, wherein when the processor executes the computer program, the method according to claim 2 is implemented.

15. A computer device, comprising a memory, a processor and a computer program stored in the memory and executable on the processor, wherein when the processor executes the computer program, the method according to claim 3 is implemented.

16. A computer device, comprising a memory, a processor and a computer program stored in the memory and executable on the processor, wherein when the processor executes the computer program, the method according to claim 4 is implemented.

17. A computer device, comprising a memory, a processor and a computer program stored in the memory and executable on the processor, wherein when the processor executes the computer program, the method according to claim 5 is implemented.

18. A computer device, comprising a memory, a processor and a computer program stored in the memory and executable on the processor, wherein when the processor executes the computer program, the method according to claim 6 is implemented.

19. A computer device, comprising a memory, a processor and a computer program stored in the memory and executable on the processor, wherein when the processor executes the computer program, the method according to claim 7 is implemented.

20. A computer device, comprising a memory, a processor and a computer program stored in the memory and executable on the processor, wherein when the processor executes the computer program, the method according to claim 8 is implemented.
